(19) United States
(12) Patent Application Publication
(10) Pub. No.: US 2012/0069066 A1
(43) Pub. Date: Mar. 22, 2012

(54) Method and Apparatus of Direct Inkjet Offset Lithographic Printing System

(76) Inventor: DINO PARO, Moncalieri-Torino (IT)

(21) Appl. No.: 12/831,736

(22) Filed: Jul. 7, 2010

(51) Int. Cl. B41J 29/38; B05D 3/12

(52) U.S. Cl. 347/5; 427/327

(57) ABSTRACT

A method of producing an offset lithographic printing plate including the steps of graining and anodizing an aluminum plate; applying a receptive coating to the grained aluminum; applying an oleophilic inkjet fluid on top of the receptive coating; applying energy to the oleophilic inkjet fluid allowing an oleophilic resin of the oleophilic inkjet fluid to bond with the grained aluminum; and removing a portion of the receptive coating to expose part of the grained aluminum. The step of applying receptive coating can include obtaining a solution having a specific pH range, and maintaining a specific temperature range. A first immersion step is taken to immerse the aluminum plate in the solution, followed by rinsing with a portion of demineralized water. The invention can also include a second immersion step to immerse the aluminum plate in a surfactant water solution.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### BACKGROUND OF THE INVENTION

(1) Field of the Invention

The field of the invention is printing technology, more specifically, direct inkjet lithographic printing technology.

(2) Description of Related Art including Information Disclosed under 37 CFR 1.97 and 1.98

Offset printing is widely known for printing books and newspapers. In offset printing, the inked image is transferred (or “offset”) from a plate to a rubber blanket, then to the printing surface.

Lithographic process, on the other hand, is based on the principle of repulsion of oil and water. When this is used in combination with offset printing, the offset technique employs a flat (planographic) image carrier on which the image to be printed obtains ink from ink rollers, while the non-printing area attracts a film of water, keeping the non-printing areas ink-free.

There has been previous attempts to apply “direct” inkjet printing techniques to lithographic printing. For example, European Patent Publication No. 503,621 (herein incorporated by reference in its entirety) discloses a direct lithographic plate making method which includes jetting a photocuring ink onto the plate substrate, and exposing the plate to UV radiation to harden the image area. An oil-based ink may then be transferred to the image area for printing onto a printing medium. However, the resolution of the ink droplets jetted onto the substrate is undesirable, and the durability of the lithographic printing plate with respect to printing run length is also undesirable.

U.S. Pat. No. 6,758,140 discloses a method for preparing lithographic printing plates including the steps of: (a) coating a substrate with a mixture including colloidal silica, fumed alumina, polyethylenimine, a quaternary ammonium polymer and a hardener; (b) utilizing an inkjet printer with pigmented inks to print a digital image on said coated substrate; and (c) drying the image. The problem with this is that the printing plate with a porous layer to accept the ink jet drops causes spreading of the inkjet fluid and lacks the high resolution and sharp edges needed for quality printing.

U.S. Pat. No. 6,245,421, discloses a printable media including: (a) a substrate having a hydrophilic, porous layer on at least one surface, the hydrophilic layer comprising a water soluble binder, a hardening agent and a clay; and (b) an ink receptive, thermoplastic image layer adhered to the hydrophilic porous layer, wherein the ink receptive layer contains a copolymer having a low surface energy and a plurality of tertiary amine sites, the amine sites being at least partially neutralized with an acid. The disadvantage of this method is by using the hydrophilic porous layer, the high resolution and sharp edges needed for quality printing are difficult to be achieved.

U.S. Pat. No. 6,276,273 discloses a printing plate precursor for direct receipt of an image-wise applied ink receptive layer, comprising a desorbable surfactant adsorbed on at least one surface of a printing plate substrate, wherein the desorbable surfactant is present in an amount effective to improve the resolution of the subsequently image-wise applied ink receptive layer, and the desorbable surfactant is discontinuously adsorbed on said printing plate substrate. However, the discontinuous nature of the printing plate substrate limits the quality and uniformity of the printed image.

Also, it has been known to improve the resolution of inkjet printers by applying an ink receiving layer to substrates such as metal, plastic, rubber, fabrics, leather, glass and ceramics, prior to printing thereon. Some examples can be found in European Patent Publication No. 738,608 (herein incorporated by reference in its entirety) which discloses a thermally curable ink receiving layer containing a first water soluble high molecular weight compound having a cationic site in the main compound and having a side chain containing a condensable functional site. Alternatively, the second high molecular weight compound may be replaced with a monomer or oligomer having at least two (meth)acryloyl sites, which results in a UV radiation curable ink receiving layer.

Also, chemical process is often used in the process for producing a lithographic printing plate. For example, U.S. Pat. No. 6,691,618 discloses a process for imaging a lithographic printing plate having a presensitizing coating, comprising the steps in sequence of: a) blanket exposing the coating; and b) image-wise applying droplets of an insolubilizing chemical in a solvent carrier to the coating.

Improving resolution of the printing has always been a challenge. Despite numerous attempts to improve resolution, however, there continues to be a need for improving printing resolution. In addition, there remains a need for producing a process less and long running printing plate by inkjet printing without chemical processing.

All referenced patents, applications and literatures are incorporated herein by reference in their entirety. Furthermore, where a definition or use of a term in a reference, which is incorporated by reference herein, is inconsistent or contrary to the definition of that term provided herein, the definition of that term provided herein applies and the definition of that term in the reference does not apply. The invention may seek to satisfy one or more of the above-mentioned desires. Although the present invention may obviate one or more of the above-mentioned desires, it should be understood that some aspects of the invention might not necessarily obviate them.

### BRIEF SUMMARY OF THE INVENTION

It is an object of this invention to produce a high resolution offset printing plate by means of an inkjet printer.

It is a another object of this invention to produce a long running offset printing plate by means of an inkjet printer.

It is a another object of this invention to produce an offset printing plate by means of an inkjet printer which does not require chemical processing after imaging.

These objects are achieved by the method of producing a direct inkjet offset lithographic printing plate disclosed herein. In the preferred embodiment, the method generally comprises steps of graining and anodizing an aluminum plate to create a grained aluminum; applying a receptive coating to the grained aluminum; applying an oleophilic inkjet fluid on top of the receptive coating; applying sufficient energy to the oleophilic inkjet fluid allowing an oleophilic resin of the oleophilic inkjet fluid to bond with the grained aluminum; and removing a portion of the receptive coating to expose a surface of the grained aluminum.

Producing typical aluminum lithographic offset plate involves the following: degreasing, neutralization, electrochemichally graining, desmut, anodizing, post-treatment, coating, drying.

Typical aluminum offset pre-sensitized analog or CTP (computer-to-plate) plate have in common the base, anodized aluminum electrochemical graining, anodizing and applying the interlayer (silicate, phosphate, polyvinyl phosphate). The difference between some of the plates are on two processes: post-treatment, and coating.

In the instant application, the post-treatment is used to give consistency and reactivity at the oxide that has formed on the surface of the plate during the process of production and provide a proper interfacial tension.

In the instant application, the coating provides a hydrophobic property to the blank plate where the image is produced.

In traditional pre-sensitized plate or CTP plate, an hydrophobic coating is applied uniformly to the entire surface of the plate during the process of production. Part of this coating is removed from the surface during the development phase with appropriate chemical developers.

In an embodiment of the present invention, however, the hydrophobic coating is a water-based inkjet fluid which attracts printing ink when dried. It is applied to the offset plate in a digital method (via inkjet print head). The inkjet fluid reacts with the plate oxide, and after baking with infrared energy the plate has the capability to print more than 100,000 copies.

In one preferred embodiment, the receptive coating on the aluminum printing plate is made by bathing the plate in a plate preparation fluid, followed by drying the plate. The preferred plate preparation fluid is an aqueous solution of one or more water soluble polymers and one or more surfactants, with a pH greater than 10. The water soluble polymers include polyvinyl alcohol, polyethyl oxazoline, polyvinyl pyrollidone, hydroxyethylcellulose, agarose, polyacrylamide, and polyethyleneoxide.

The surfactants in the plate preparation fluid are chosen from commercial surfactants to provide a low enough surface energy so that the printed drops of inkjet fluid do not spread and lower the resolution of the final printing plate. This criterion is satisfied when the contact angle of the droplet of inkjet fluid on the plate is 90 degrees or less. In a preferred embodiment of the invention, the contact angle is 45 degrees or less. The surfactants useful in this embodiment include Surfynol 2502, Igepal CO-520, Triton X-100, and the sodium salt of the half ester of sulphosuccinic acid. The pH of the plate preparation fluid is adjusted to a value larger than 10, and in preferred embodiments of the invention, to a pH between 11.5 to 11.8, by the addition a common base such as sodium or potassium hydroxide, or trisodium phosphate.

After the plate preparation fluid has been spread on the aluminum plate, the plate is dried. The drying can be achieved by allowing the plate to sit quietly at room temperature to dry, or the drying process can be accelerated with a warm air blower such as a common hair dryer, or by passing the plate under an infrared radiation source such as a “glow bar”.

In another preferred embodiment, the step of applying receptive coating includes obtaining a solution having a pH in a range of 11.5 to 11.8, and maintaining a temperature in such solution to 35° C.+/−5%. Further, a first immersion step is taken to immerse the aluminum plate in the solution followed by removing the aluminum plate from the solution after the first immersion step.

Thereafter, the aluminum plate is rinsed after the first immersion step with a portion of demineralized water.

In yet other embodiments, a second immersion step is used to immerse the aluminum plate in a surfactant water solution followed by a drying step to dry the plate.

In further embodiments, the inventive method includes modifying the interfacial tension on the surface such that the inkjet fluid has a surface tension that is higher than the interfacial tension. The contemplated method further includes a step to maintain the hydrophilic characteristic of the surface by using the receptive coating where the receptive coating is a water soluble film having a surface tension that is lower than the inkjet fluid.

Among the many different possibilities contemplated, the second immersion step may take place within 30 seconds following a completion of the rising step.

It is further contemplated that the first immersing step has a dwell time of between 30 to 60 seconds, and wherein the second immersing step has a dwell time of between 30 to 60 seconds.

In the preferred embodiments, the solution contains deionized water and sodium hydroxide.

In still further preferred embodiments, the oleophilic inkjet fluid comprises about 78% HPLC grade water, about 7.7% of a polymer of one or a plurality of monomers selected from styrene, vinyl acetate, vinyl toluene and acrylic or methacrylic acid esters of alcohols of one to four carbon atoms and a minor amount of acrylic or methacrylic acid, about 1.5% concentrated ammonia (33%), about 0.35% diol surfactant Acetylene, about 0.27% Surfactant Disodium salt of half ester of sulphosuccinic acid in water, about 3.47% Surfactant nonionic polyoxyethylene Ether Tridecyl, about 7.5% Complexing agent Triethanolamine; and about 1% Coloring dye.

Preferably, the step of applying energy comprises applying energy to the oleophilic inkjet fluid to a temperature of between 190 to 210° C., with a dwell time of between 4-10 minutes.

The inventive subject matter also contemplates a method of improving resolution in direct inkjet offset lithographic printing, where the contemplated method includes the method steps of providing a printer having a grained aluminum as a substrate; applying a low surface tension coating to the grained aluminum; applying an higher surface tension inkjet fluid on top of the receptive coating to create a desired image area; applying energy to the inkjet fluid allowing an oleophilic resin of the inkjet fluid to bond with the grained aluminum; using a dampening system to wash away a portion of the coating to expose a hydrophilic surface of the grained aluminum; and applying ink to the image area.

In some preferred embodiments, the step of applying the receptive coating comprises preparing a solution having a pH higher than 9; maintaining a temperature in the solution to 35° C.+/−5%; first immersing the aluminum plate in the solution; removing the aluminum plate from the solution after the first immersion step; rinsing the aluminum plate after the first immersion step with a portion of demineralized water; and immersing the aluminum plate in a second surfactant water solution.

The contemplated inventive method can also include a solution that has a portion of deionized water and a portion of sodium hydroxide.

Another aspect of the inventive subject matter is a direct inkjet offset lithographic printing system with improved resolution, the system including a housing; a print head disposed within the housing to digitally place droplets of inkjet fluid on the plate, where the inkjet fluid has a higher surface tension than the coated plate; an offset plate disposed within the housing; a dampening system coupled to the offset plate; and wherein the plate has a hydrophilic surface.

In one contemplated embodiment, the plate has a coating on the surface of the plate, and the coating has a surface tension that is lower than the surface tension of the inkjet fluid.

In yet another contemplated embodiment, the system has a coating applicator in the housing to apply the coating onto the offset plate.

The contemplated direct inkjet offset lithographic printing system preferably has a dampening system that washes at least a portion of the receptive coating off of the offset plate.

In some embodiments, the system further includes a Far IR energy applicator disposed within the housing to apply energy to the offset plate.

Essentially, in the preferred embodiment, the thermo chemical surface treatment creates hydrophobic and hydrophilic characteristics on the oxide on the surface of the offset plate which allows for much improved resolution in printing. The hydrophobic product applied during a post treatment of the plate can then be removed from the surface of the offset plate with the washing roller during the printing process.

Additionally, the novel chemical composition and thermal polymerization of the water-based fluid applied with the digital inkjet system creates the desired improvement in resolution.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

It should be noted that the drawing figures may be in simplified form and might not be to precise scale. In reference to the disclosure herein, for purposes of convenience and clarity only, directional terms, such as, top, bottom, left, right, up, down, over, above, below, beneath, rear, front, distal, and proximal are used with respect to the accompanying drawings. Such directional terms should not be construed to limit the scope of the invention in any manner.

FIG. 1 is an illustration of an embodiment of a the contemplated aluminum plate converted into a plate with a coating, according to an aspect of the inventive subject matter.

FIG. 2 is an illustration of an embodiment of a the contemplated aluminum plate with an oleophilic inkjet fluid being added, according to an aspect of the inventive subject matter.

FIG. 3 is an illustration of an embodiment of a the contemplated aluminum plate where an energy is being applied to the plate, according to an aspect of the inventive subject matter.

FIG. 4 is an illustration of an embodiment of a the contemplated aluminum plate being processed by a dampening system, according to an aspect of the inventive subject matter.

FIG. 5 is an illustration of an embodiment of a the contemplated aluminum plate on the press, according to an aspect of the inventive subject matter.

FIG. 6 is an illustration of an embodiment of a the contemplated printing system, according to an aspect of the inventive subject matter.

### DETAILED DESCRIPTION OF THE INVENTION

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The inventors have discovered a novel method of producing a direct inkjet offset lithographic printing plate.

Typically, after transfer of an image onto an analog or digital plate, the plate in a typical printing system needs to be developed with appropriate chemicals, which includes a developer to bring out the image and a finisher to protect the unimaged areas from oxidation and fingerprints and to promote dampening of the same area on press.

The present invention provides a method to completely eliminate these chemicals. In a way, this novel method delivers a “process-less” offset printing plates.

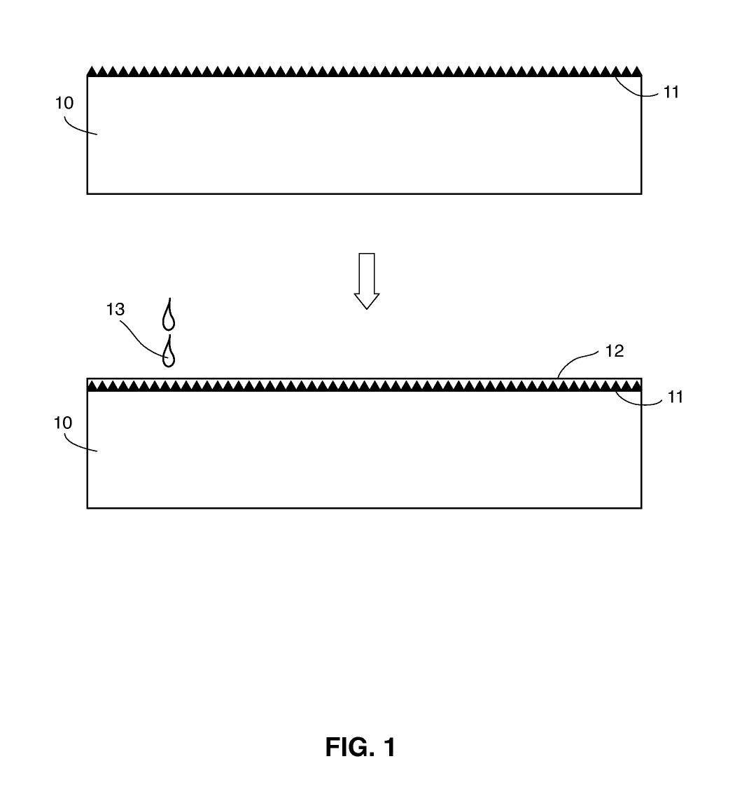

Referring now to FIG. 1, in the preferred embodiment, the method generally comprises steps of graining and anodizing an aluminum offset plate 10 to create a grained aluminum plate surface.

The contemplated plate 10 can also be made of other suitable materials with inherent hydrophilic surface properties, such materials include natural and synthetic polymers, various metals and metal alloys, naturally occurring materials, and all reasonable combinations thereof.

Next, a receptive coating 12 is applied to the grained aluminum 10. FIG. 1 shows a simplified illustration of adding a solution 13 onto the plate 10 to create a coating 12 on the plate 10. In operation, the solution 13 can or cannot be directly placed on the plate 10 as shown in FIG. 1. And, the solution 13 can be optionally applied via immersion steps to be discussed in more detail below.

In a preferred embodiment, the step of applying receptive coating 12 includes first having a solution with a pH in a range of 11.5 to 11.8, and maintaining a temperature in such solution to 35° C.+/−5%. Then, immersing the aluminum plate 10 in the solution followed by removing the aluminum plate 10 from the solution. Thereafter, the aluminum plate 10 is rinsed with a sufficient portion of demineralized water. A suitable time of rinsing can be less than 60 seconds, or preferably less than 30 seconds, or most preferably less than 10 seconds. Preferably, the plate 10 is rinsed for 5-8 seconds. Although immersion is preferred, one skilled in the art would immediately recognize that the solution may also be applied onto the plate 10 by other methods, such as by spraying the solution onto the plate, or wiping with a cotton pad soaked in the solution, as is well known in the art as “wipe on plates”.

Contemplated receptive coating 12 can also start with a solution with a pH in a range of 9 to 12, maintaining a temperature in such a solution at 30-40° C. Preferably, receptive coating 12 can also start with a solution with a pH in a range of 11 to 12, and maintaining a temperature in such a solution at 34-36° C.

In yet other embodiments, a second immersion step is used to immerse the aluminum plate in a surfactant water solution followed by a drying step to dry the plate. All suitable surfactants can be used, as one skilled in the art would readily recognize.

Among the many different possibilities contemplated, the second immersion step takes place within 100 seconds following a completion of the rising step. More preferably, the second immersion step takes place within 60 seconds, even more preferably, within 30 seconds, and most preferably, within 15 seconds.

1. It is further contemplated that the first immersing step has a dwell time of between 10 to 120 seconds, or preferably 20 to 100 seconds, or most preferably 30 to 60 seconds. As for the second immersing step, it has a dwell time of between 10 to 120 seconds, or preferably 20 to 100 seconds, or most preferably 30 to 60 seconds.

In the preferred embodiments, the solution has a portion of deionized water and a portion of sodium hydroxide.

However, in another preferred embodiment, the step of applying receptive coating 12 includes immersing the aluminum plate 10 in a plate preparation fluid followed by drying the plate. Although immersion is preferred, one skilled in the art would immediately recognize that the solution may also be applied onto the plate 10 by other methods, such as by spraying the solution onto the plate. In the preferred embodiment, the drying is achieved by allowing the plate to sit quietly at room temperature to dry, or the drying process can be accelerated with a warm air blower such as a common hair dryer, or by passing the plate under an infrared radiation source such as a “glow bar”.

In the preferred embodiments, the plate preparation fluid is an aqueous solution of one or a plurality of water soluble polymers and one or a plurality of surfactants, with a pH greater than 10. Among the many different possibilities contemplated, the water soluble polymers include polyvinyl alcohol, polyethyl oxazoline, polyvinyl pyrollidone, hydroxyethylcellulose, agarose, polyacrylamide, and polyethyleneoxide. Among the many different possibilities contemplated, the surfactants include Surfynol 2502, Igepal CO-520, Triton X-100, and the sodium salt of the half ester of sulphosuccinic acid. In one embodiment, the pH of the plate preparation fluid is adjusted to a value larger than 10. However preferably, the pH of the plate preparation fluid is adjusted to a pH between 11.5 to 11.8 with the addition a common base such as sodium or potassium hydroxide, or trisodium phosphate.

In the preferred embodiments, the surfactants in the plate preparation fluid are chosen from commercial surfactants to provide a low enough surface energy so that the printed drops of inkjet fluid do not spread and lower the resolution of the final printing plate.

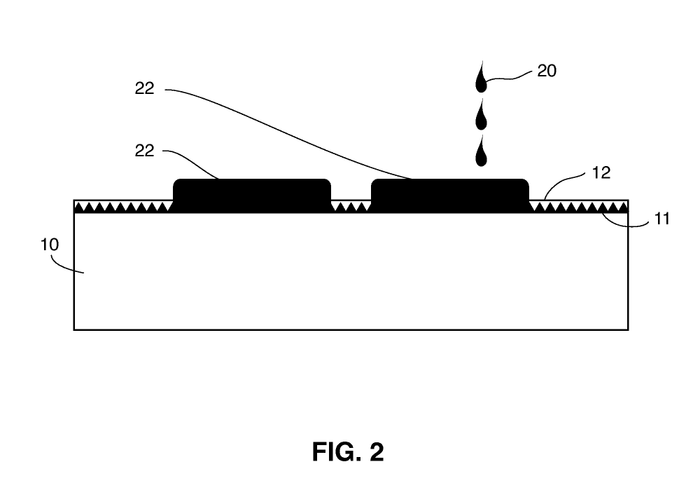

As illustrated in FIG. 2, this is further followed by applying an oleophilic inkjet fluid 20 on top of the receptive coating 12. In a preferred embodiment, this is done by a piezo-electric print head, similar to that described in U.S. Pat. No. 6,906,019, which is herein incorporated by reference in its entirety.

In one embodiment, the inkjet fluid is water-based and is applied with a high resolution piezo print head. The “drop on demand” nature of the technology only places ink where the digital image requires it to be.

In addition, there will be a step of applying sufficient energy 30 to the oleophilic inkjet fluid area 22, allowing an oleophilic resin of the oleophilic inkjet fluid to bond with the grained aluminum 10, and a step of removing a portion of the receptive coating using a dampening system 40 to wash off the receptive coating 12, thereby exposing a surface 11 of the grained aluminum 10 to work as the hydrophilic surface.

It should be noted that any immersion steps mentioned in this specification can also be replaced by a spraying process as known in the art.

In the preferred embodiments, the contact angle of the droplet of inkjet fluid on the plate is 90 degrees or less to produce high resolution of the final printing plate. Yet in other preferred embodiments, the contact angle is 45 degrees or less.

Contemplated dampening system 40 can be any suitable known dampening system in the field, such as an intermittent-flow dampening system, or a continuous-flow dampening system. One skilled in the art would immediately recognize the necessary dampening system needed for the instant applications.

In further embodiments, the inventive method includes novel steps to modify the interfacial tension on the surface 11 such that the inkjet fluid 20 has a surface tension that is higher than the interfacial tension on the surface 11. For example, one of the purposes of the receptive coating 12 is to maintain a hydrophilic characteristic of the surface 11 by creating a water soluble film as the receptive coating 12 having a surface tension that is lower than the inkjet fluid 20. The receptive coating 12 provides a stable base for the oleophilic fluid 20, and keeps the ink dot 22 (oleophilic image area) from spreading sideways. This creates a desired high resolution image on the developed planographic printing plate having oleophilic image areas and hydrophilic non-image areas.

In still further contemplated embodiments, the oleophilic inkjet fluid 20 comprises about 78% HPLC grade water, about 8% of a polymer of one or a plurality of monomers selected from styrene, vinyl acetate, vinyl toluene and acrylic or methacrylic acid esters of alcohols of one to four carbon atoms and a minor amount of acrylic or methacrylic acid, about 1.5% ammonia 33%, about 0.35% diol surfactant Acetylene, about 0.27% Surfactant Disodium salt of half ester of sulphosuccinic acid in water, about 3.5% Surfactant nonionic Polyoxyethylene Ether Tridecyl, about 7.5% Complexing ion Triethanolamine; and about 1% Coloring dye.

In still further contemplated embodiments, the oleophilic inkjet fluid 20 comprises a polymeric emulsion which is oleophillic when dried on the printing plate. In one embodiment, such emulsions are formed by emulsion polymerization of one or a plurality of monomers selected from styrene, vinyl acetate, vinyl toluene and acrylic or methacrylic acid esters of alcohols of one to four carbon atoms and a minor amount of acrylic or methacrylic acid. The emulsion is stabilized by ammonia which ionizes the acrylic or methacrylic acid in the emulsion. When dried, the ammonia evaporates and the emulsion coalesces into a tough insoluble resin that is oleophilic to attract the offset printing ink.

In still further contemplated embodiments, the viscosity of the oleophilic inkjet fluid 20 is adjusted by the addition of thickeners such as triethanolamine and glycerin. High resolution inkjet printing requires an inkjet fluid with a viscosity between 2 and 10 centipoises, and preferably between 4 and 6 centipoises. In the preferred embodiment, the inkjet fluid has a surface tension of approximately 30 dynes/centimeter. In essence, too high a surface tension produces large drops that may not break free when the inkjet head is pulsed. Too low a surface tension may produce a spray of very small drops producing an incoherent image. Also, low surface tension in the inkjet fluid drop will cause the drop to spread on the printing plate before it is dried. In the preferred embodiment, the correct type and amount of surfactant is added to the inkjet fluid to produce a surface tension from about 20 to about 40 dynes/centimeter to give a high resolution image.

In operation, the step of applying energy comprises applying energy 30 to the oleophilic inkjet fluid 20 to a temperature of between 150 to 250° C., with a dwell time of between 2-20 minutes. Preferably, the temperature is between 180 to 230° C., with a dwell time of between 3-15 minutes. Most preferably, the temperature is between 190 to 210° C., with a dwell time of between 4-10 minutes. In one example, desirable properties were obtained by using Far IR energy 30 to reach an elevated temperature of 200° C. for five minutes. In another embodiment, desirable properties were obtained by using Far IR energy 30 to reach an elevated temperature of 205° C. for six minutes. In the process, the oleophilic resin bonds with the grained aluminum 10. This results in a sharpened bonded image, improving image quality.

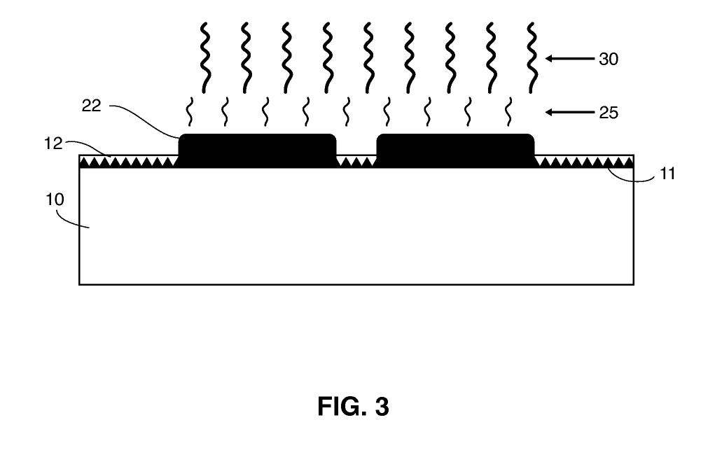

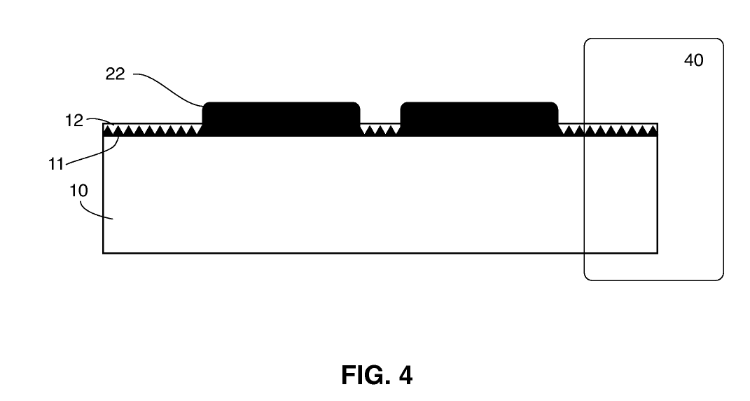

In essence, the inventive subject matter drastically improves resolution in direct inkjet offset lithographic printing by providing a grained aluminum 10 as a substrate with a low surface tension coating 12 to the grained aluminum 10, followed by applying an high surface tension inkjet fluid 20 on top of the receptive coating 12 to create a desired image area 22. As shown in FIG. 2, a digitally placed ink droplet 20 lands on the ink receptive coating 12, and soaks through to the grained/anodized aluminum 10. And as illustrated in FIG. 3, energy 30 is then applied to the inkjet fluid 20 allowing the oleophilic resin of the inkjet fluid 20 to bond with the grained aluminum 10. FIG. 4 shows a simplified representation of dampening system 40 to wash away a portion of the coating 12 to expose a hydrophilic surface 11 of the grained aluminum 10. The plate 10 is now ready for ink to be applied to the image area 22 by a press 50.

Contemplated dampening of the plate 10 can be done before or during inking, where the inking is with an oil-based ink composition. In the preferred embodiments, the dampening process utilizes an aqueous fountain solution such as those described in U.S. Pat. Nos. 3,877,372, 4,278,467 and 4,854,969 (all of which are herein incorporated by reference in their entireties). When water is applied to the plate 10, the water will form a film on the hydrophilic areas (i.e., the non-image areas of the plate 10) but will contract into tiny droplets on the oleophilic plate areas 22 (i.e., the image areas). When a roller 50 carrying an oil-based ink composition is passed over the dampened plate 10, it will be unable to ink the areas covered by the aqueous film (non-image areas) but will emulsify the water droplets on the water repellent areas (the image areas 22) which will then take up ink. The resulting ink image is transferred (“offset”) onto a rubber blanket, which is then used to print a substrate such as paper.

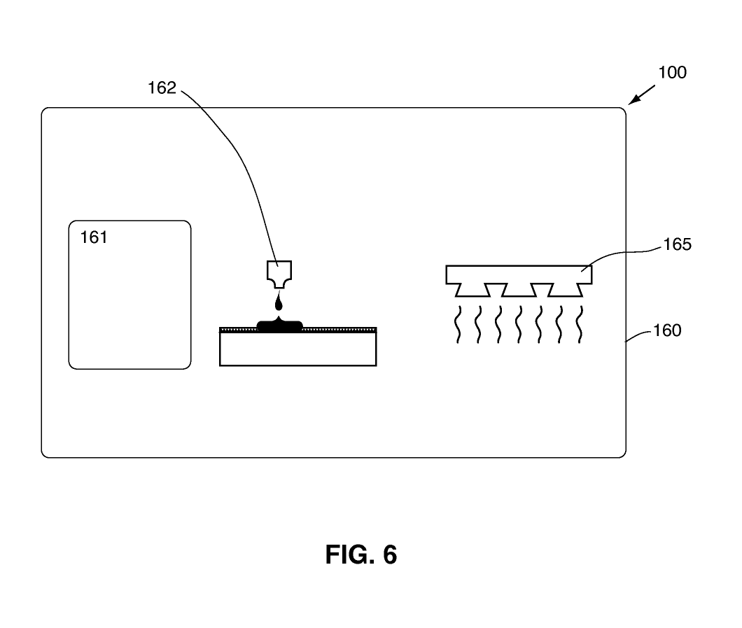

Referring now to FIG. 6, another aspect of the inventive subject matter is a direct inkjet offset lithographic printing system 100 with improved resolution. The system includes a housing 160, a print head 162 disposed within the housing 160 to digitally place droplets of inkjet fluid 120 on an offset plate 110 within the housing, where the inkjet fluid 120 has a relatively high surface tension. While the plate 110 is shown in the simplified drawing figures as a flat plate, contemplated embodiments of the plate can include various shapes, including having curved surfaces on a cylindrical roller structure.

In one contemplated embodiment, the plate 110 has a coating 112 on the surface 111 of the plate, and the coating 112 has a surface tension that is lower than the surface tension of the inkjet fluid 120.

In yet another contemplated embodiment, the system 100 has optionally a coating applicator 161 in the housing 160 to apply the necessary solution as discussed above to create the coating 112 on the offset plate 110. Contemplated applicator includes, and are not limited to, a sprayer, an immersion tank, a direct-contact applicator such as a brush.

In some embodiments, the system further includes a Far IR energy applicator 165 disposed within the housing 160 to apply energy to the offset plate.

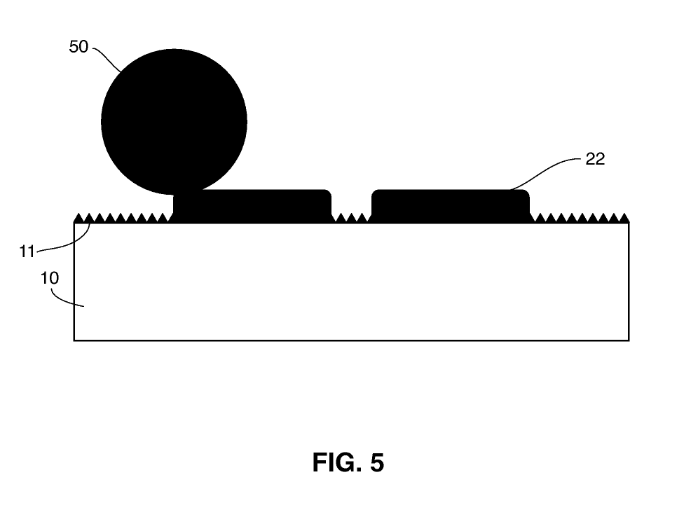

The printing system 100 optionally has a dampening system 140 coupled to the offset plate 110 with a hydrophilic surface 111. The dampening system 140 washes off the portion of the receptive coating 112 that are not covered by the image area 22 as illustrated in FIGS. 2-5.

Contemplated printing systems exhibit the following advantages:
1) The plate 10 does not require a chemical interlayer (phosphate, silicate or PVPA) found in typical commercial printing plates.
2) The ink fluid receptive coating 12 does not require a primer or other pretreatment to adhere to the grained aluminum 10.
3) Once imaging the plate is completed, no further chemical process is required.
4) The inkjet ink receptive coating 12 acts as the oxygen barrier, thus eliminating the need for finisher/gum.
5) The inkjet ink receptive coating 12 works with the dampening solution to maintain the ink water balance on the printing plate 10.
6) Polymerizing inkjet fluid provides exceptional qualities on press durability, wherein no additional post-treatment is required to achieve long commercial press runs.

The following are examples of embodiments according to the instant inventive subject matter.

### Example 1

Technical characteristics of “Process-Less” DWS-plate:

| | |
|---|---|
| Electrochemical graining Ra. | 0.55-0.70 |
| Oxide Gr/SQM | 2-3 |

Coating:
Deionized water
Sodium hydroxide 1:4
Increases the pH of the deionized water to a range of 11.5 to 11.8.
Temperature ° C. 35 +/− 5%
Immerse the plate in the solution for a dwell time of 40 seconds
Squeegee the surface, rinse with demineralized water for
5-8 sec, squeegee the surface.
Immediately immerse the plate in a Surfactant 3% Water solution
of mono-di-alkyl disulphonated diphenyloxide, disodium salt.
Cationic fluorosurfactant 0.001%
Vegetable Surfactant 0.01%
Demineralized water 97%
Dwell time 40 seconds
Squeegee process
Dry, using an IR dryer
Technical characteristics of DWS inkjet fluid

| HPLC grade water | 405 | cc, 78.17% |
|---|---|---|
| Polymerization of one or a pluarity of monomers | 40 | gr. 7.72% |
| selected from styrene, vinyl acetate, vinyl toluene | | |
| and acrylic or methacrylic acid esters of alcohols of | | |
| one to four carbon atoms and a minor amount | | |
| of acrylic or methacrylic acid | | |
| ammonia 33% | 7.8 | cc. 1.5% |
| Diol surfactant Acetylene | 1.82 | gr. 0.35% |
| Surfactant Disodium salt of half ester of | 1.45 | cc. 0.27% |
| sulphosuccinic acid in water | | |
| Surfactant nonionico Polyoxyethylene Ether Tridecyl | 18 | gr. 3.47% |
| Complexing ion Triethanolamine | 39 | gr. 7.52% |
| Coloring dye | 5.0 | gr. 0.96% |

Polymerization of the Inkjet Fluid-Curing with IR Irradiation.
The inkjet fluid brought to a temperature of 200° C.,
with a dwell time of 5 minutes.

### Example 2

Technical characteristics of “Process-Less” DWS-plate:

| | |
|---|---|
| Electrochemical graining Ra. | 0.55-0.70 |
| Oxide Gr/SQM | 2-3 |

Coating:
Deionized water
Sodium hydroxide 1:4
Increases the pH of the deionized water to a range of 11.5 to 11.8.
Temperature ° C. 35 +/− 5%
Immerse the plate in the solution for a dwell time of 40 seconds
Squeegee the surface, rinse with demineralized water for
5-8 sec, squeegee the surface.
Immediately immerse the plate in a Surfactant 3% Water solution
of mono-di-alkyl disulphonated diphenyloxide, disodium salt.
Cationic fluorosurfactant 0.001%
Demineralized water 97%
Dwell time 40 seconds
Squeegee process
Dry, using an IR dryer
Technical characteristics of DWS inkjet fluid

| HPLC grade water | 405 | cc, 78.17% |
|---|---|---|
| Polymerization of one or a pluarity of monomers | 40 | gr. 7.72% |
| selected from styrene, vinyl acetate, vinyl | | |
| toluene and acrylic or methacrylic acid esters of | | |
| alcohols of one to four carbon atoms and a minor | | |
| amount of acrylic or methacrylic acid | | |
| ammonia 33% | 7.8 | cc. 1.5% |
| Diol surfactant Acetylene | 1.82 | gr. 0.35% |
| Surfactant Disodium salt of half ester of | 1.45 | cc. 0.27% |
| sulphosuccinic acid in water | | |
| Surfactant nonionico Polyoxyethylene Ether | 18 | gr. 3.47% |
| Tridecyl | | |
| Complexing ion Triethanolamine | 39 | gr. 7.52% |
| Coloring dye | 5.0 | gr. 0.96% |

Polymerization of the Inkjet Fluid - Curing with IR Irradiation.
The inkjet fluid brought to a temperature of 200° C., with a
dwell time of 5 minutes.

### Example 3

Technical characteristics of “Process-Less” DWS-plate:

| | |
|---|---|
| Electrochemical graining Ra. | 0.55-0.70 |
| Oxide Gr/SQM | 2-3 |

Coating:
Demineralized water 95.5%
Sodium hydroxide 1%
Monomeric (C₂H₄O)ₙ 0.5%
Cationic Fluoropolymer 0.001%
Surfactant solution (mono-di-alkyl disulphonated diphenyloxide,
disodium salt) 3%
Temperature ° C. 35 +/− 5%
Immersion treatment with dwell time of 40 seconds
Squeegee process
Dry, using an IR dryer
Technical characteristics of DWS inkjet fluid

| HPLC grade water | 405 | cc, 78.17% |
|---|---|---|
| Polymerization of one or a pluarity of monomers | 40 | gr. 7.72% |
| selected from styrene, vinyl acetate, vinyl | | |
| toluene and acrylic or methacrylic acid esters of | | |
| alcohols of one to four carbon atoms and a minor | | |
| amount of acrylic or methacrylic acid | | |
| ammonia 33% | 7.8 | cc. 1.5% |
| Diol surfactant Acetylene | 1.82 | gr. 0.35% |
| Surfactant Disodium salt of half ester of | 1.45 | cc. 0.27% |
| sulphosuccinic acid in water | | |
| Surfactant nonionico Polyoxyethylene Ether | 18 | gr. 3.47% |
| Tridecyl | | |
| Complexing ion Triethanolamine | 39 | gr. 7.52% |
| Coloring dye | 5.0 | gr. 0.96% |

Polymerization of the Inkjet Fluid - Curing with IR Irradiation.
The inkjet fluid brought to a temperature of 205° C., with a
dwell time of 5 minutes. Use inkjet piezo drop on demand.

### Example 4

Technical characteristics of “Process-Less” DWS-plate:

| | |
|---|---|
| Electrochemical graining Ra. | 0.55-0.70 |
| Oxide Gr/SQM | 2-3 |

Coating:
Deionized water
Sodium hydroxide 1:4
Increases the pH of the deionized water using NaOH to a
range of 11.5 to 11.8
Temperature ° C. 35 +/− 5%
Immerse the plate in the solution for a dwell time of 40 seconds
Squeegee the surface, rinse with demineralized water for 5-8 sec,
squeegee the surface, and dry the surface
Immediately immerse the plate in a Surfactant 3% (30 ml) water
solution of mono-di-alkyl disulphonated diphenyloxide, disodium salt.
Cationic fluorosurfactant 0.001% (0.01 ml)
Vegetable Surfactant 0.01% (1 ml)
Demineralized water 97% (970 ml)
Dwell time 40 seconds
Squeegee process
Dry
Technical characteristics of DWS inkjet fluid

| HPLC grade water | 405 | cc, 78.17% |
|---|---|---|
| Polymerization of one or a pluarity of monomers | 40 | gr. 7.72% |
| selected from styrene, vinyl acetate, vinyl | | |
| toluene and acrylic or methacrylic acid esters of | | |
| alcohols of one to four carbon atoms and a minor | | |
| amount of acrylic or methacrylic acid | | |
| ammonia 33% | 7.8 | cc. 1.5% |
| Diol surfactant Acetylene | 1.82 | gr. 0.35% |
| Surfactant Disodium salt of half ester of | 1.45 | cc. 0.27% |
| sulphosuccinic acid in water | | |
| Surfactant nonionico Polyoxyethylene Ether | 18 | gr. 3.47% |
| Tridecyl | | |
| Complexing ion Triethanolamine | 39 | gr. 7.52% |
| Coloring dye | 5.0 | gr. 0.96% |

Polymerization of the Inkjet Fluid - Curing with IR Irradiation.
The inkjet fluid brought to a temperature of 205° C., with a
dwell time of 6 minutes.

### Example 5

Technical characteristics of “Process-Less” DWS-plate:

| | |
|---|---|
| Electrochemical graining Ra. | 0.55-0.70 |
| Oxide Gr/SQM | 2-3 |

Coating:
Deionized water
Sodium hydroxide 1:4
Increases the pH of the deionized water using NaOH to a range of
11.5 to 11.8
Temperature ° C. 35 +/− 5%
Immerse the plate in the solution for a dwell time of 40 seconds
Squeegee the surface, rinse with demineralized water for
5-8 sec, squeegee the surface, and dry the surface
Immediately immerse the plate in a Surfactant 3% (30 ml) water solution
of mono-di-alkyl disulphonated diphenyloxide, disodium salt.
Cationic fluorosurfactant 0.001% (0.01 ml)
Demineralized water 97% (970 ml)
Dwell time 40 seconds
Squeegee process
Dry
Technical characteristics of DWS inkjet fluid

| HPLC grade water | 405 | cc, 78.17% |
|---|---|---|
| Polymerization of one or a pluarity of monomers | 40 | gr. 7.72% |
| selected from styrene, vinyl acetate, vinyl toluene | | |
| and acrylic or methacrylic acid esters of alcohols of | | |
| one to four carbon atoms and a minor amount of | | |
| acrylic or methacrylic acid | | |
| ammonia 33% | 7.8 | cc. 1.5% |
| Diol surfactant Acetylene | 1.82 | gr. 0.35% |
| Surfactant Disodium salt of half ester of | 1.45 | cc. 0.27% |
| sulphosuccinic acid in water | | |
| Surfactant nonionico Polyoxyethylene Ether Tridecyl | 18 | gr. 3.47% |
| Complexing ion Triethanolamine | 39 | gr. 7.52% |
| Coloring dye | 5.0 | gr. 0.96% |

Polymerization of the Inkjet Fluid-Curing with IR Irradiation.
The inkjet fluid brought to a temperature of 205° C.,
with a dwell time of 6 minutes.

### Example 6

An exemplary process of preparing “Process-Less” DWS-plate:

An inkjet printing fluid was prepared by mixing the following ingredients:
1. 450 g water
2. 80 g of Neoryl AR-301 polymer emulsion from the Hap Dong Polymer Company
3. 8 ml of concentrated ammonia (35%)
4. 2 g Surfynol SE from Air Products Corporation
5. 40 g Triethanolamine
6. 5 g Brilliant Blue R dye (CI 42660)
   The inkjet fluid as disclosed above was loading into an Epson 900 inkjet printer and an image printed on a bare grained anodized aluminum printing plate substrate. The image was dried with a hair dryer. The dried printing plate was mounted on an ABDick printing press and used to print 100 impressions. The image was too low in resolution to be sold.

A grained anodized aluminum printing plate substrate was wiped with a cotton pad soaked in a mixture of:
85 ml water
12 g polyethyloxazoline
100 microliters Zonyl FSN surfactant
3 g di(sodiumsulphonate)diphenyloxide
Sodium hydroxide to a pH=11.5
   The plate prepared above was dried with a hair dryer. The plate was then imaged with the inkjet fluid disclosed above. The plate produced a high quality image on the ABDick press.

As those of ordinary skill in the art will recognize, the spatial arrangement and placement of the various parts within the housing 160 may readily be modified as dictated by the aesthetic or functional needs of the printer system 100.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed herein even when not initially claimed in such combinations.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Thus, specific embodiments and applications of methods and apparatus of direct inkjet offset lithographic printing system have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the invention. In addition, where the specification and claims refer to at least one of something selected from the group consisting of A, B, C . . . and N, the text should be interpreted as requiring only one element from the group, not A plus N, or B plus N, etc.

What is claimed is:

1. A method of producing an direct inkjet offset lithographic printing plate, the method comprises steps of:
graining and anodizing an aluminum plate to create a grained aluminum;
applying a receptive coating to the grained aluminum;
applying an oleophilic inkjet fluid on top of said receptive coating;
applying sufficient energy to said oleophilic inkjet fluid allowing an oleophilic resin of the oleophilic inkjet fluid to bond with said grained aluminum; and
removing a portion of said receptive coating to expose a surface of the grained aluminum.

2. The method as recited in claim 1, wherein the receptive coating on the grained aluminum comprises:
a mixture of polyethylene glycol from approximately 0.1% to approximately 1%, sodium hydroxide from approximately 0.5% to approximately 1.5%,
a surfactant from approximately 1% to approximately 5%,
a water soluble polymer from approximately 5% to approximately 50%, and sufficient water to make 100%;
wherein the surfactant selected to make a contact angle of 90 degrees or less between a sessile drop of the inkjet fluid and the aluminum plate.

3. The method as recited in claim 1, wherein the oleophilic inkjet fluid comprises:
approximately 5% to approximately 10% of an aqueous acrylic polymer emulsion formed from one or a plurality of monomers selected from styrene, vinyl acetate, vinyl toluene and acrylic or methacrylic acid esters of alcohols of 1 to 4 carbon atoms and a minor amount of acrylic or methacrylic acid, and approximately 1% to approximately 2% of a 35% solution on ammonia in water, and
approximately 0.1% to approximately 10% surfactant, wherein the surfactant selected to produce a surface tension from approximately 20 to approximately 40 dynes/centimeter to the mixture, and
approximately 5% to approximately 10% of triethanolamine, and
approximately 0.5% to approximately 1.5% dye, and
water to make 100%.

4. The method as recited in claim 1, wherein the viscosity of the injket fluid is between approximately 2 and approximately 10 centipoises.

5. The method as recited in claim 1, wherein the viscosity of the injket fluid is between approximately 4 and approximately 6 centipoises.

6. The method as recited in claim 1, wherein the step of applying receptive coating comprises:
obtaining a solution having a pH in a range of 11.5 to 11.8;
maintaining a temperature in said solution to 35° C.+/−5%;
a first immersion step to immerse the aluminum plate in the solution;
removing the aluminum plate from the solution after the first immersion step;
rinsing the aluminum plate after said first immersion step with a portion of demineralized water.
a second immersion step to immerse the aluminum plate in a surfactant water solution; and
drying the plate.

7. The method as recited in claim 1 further comprising the steps of modifying an interfacial tension on said surface such that said inkjet fluid has a surface tension that is higher than said interfacial tension.

8. The method as recited in claim 3 further providing a hydrophilic characteristic of said surface by using the receptive coating where the receptive coating is a water soluble film having a surface tension that is lower than said inkjet fluid.

9. The method as recited in claim 2, wherein the second immersion step takes place within 30 seconds following a completion of the rising step.

10. The method as recited in claim 2, wherein the first immersing step has a dwell time of between 30 to 60 seconds, and wherein the second immersing step has a dwell time of between 30 to 60 seconds.

11. The method as recited in claim 2, wherein the solution has a portion of deionized water and a portion of sodium hydroxide in 1:4 ratio.

12. The method as recited in claim 1, wherein the oleophilic inkjet fluid comprises:
about 78.17% HPLC grade water;
about 7.72 a polymer of one or a plurality of monomers selected from styrene, vinyl acetate, vinyl toluene and acrylic or methacrylic acid esters of alcohols of one to four carbon atoms and a minor amount of acrylic or methacrylic acid;
about 1.5% ammonia 33%;
about 0.35% diol surfactant Acetylene;
about 0.27% Surfactant Disodium salt of half ester of sulphosuccinic acid in water;
about 3.47% Surfactant nonionic Polyoxyethylene Ether Tridecyl;
about 7.52% Complexing ion Triethanolamine; and
about 0.96% Coloring dye.

13. The method as recited in claim 1, wherein the step of applying energy comprises applying energy to the oleophilic inkjet fluid to a temperature of between 190 to 210° C., with a dwell time of between 4-10 minutes.

14. A method of improving resolution in direct inkjet offset lithographic printing, the method comprising:
providing a printer having a grained aluminum as a substrate;
applying a low surface tension coating to the grained aluminum;
applying an high surface tension inkjet fluid on top of said receptive coating to create a desired image area;
applying energy to said inkjet fluid allowing an oleophilic resin of the inkjet fluid to bond with said grained aluminum;
using a dampening system to wash away a portion of said coating to expose a hydrophilic surface of the grained aluminum; and
applying ink to said image area.

15. The method of direct inkjet offset lithographic printing as recited in claim 10, wherein applying receptive coating comprises:
obtaining a solution having a pH higher than 9;
maintaining a temperature in said solution to 35° C.+/−5%;
a first immersion step to immerse the aluminum plate in the solution;
removing the aluminum plate from the solution after the first immersion step;
rinsing the aluminum plate after said first immersion step with a portion of demineralized water; and
a second immersion step to immerse the aluminum plate in a surfactant water solution.

16. The method of direct inkjet offset lithographic printing as recited in claim 11, wherein the solution has a portion of deionized water and a portion of sodium hydroxide.

17. A direct inkjet offset lithographic printing system with improved resolution, said system comprising:
a housing;
an offset plate disposed within the housing;
a print head disposed within the housing to digitally place droplets of inkjet fluid on the plate, where said inkjet fluid has a high surface tension;
a dampening system coupled to the offset plate;
wherein the plate has a hydrophilic surface.

18. The direct inkjet offset lithographic printing system as recited in claim 13, wherein the plate has a coating on the surface of the plate, and the coating has a surface tension that is lower than the surface tension of the inkjet fluid.

19. The direct inkjet offset lithographic printing system as recited in claim 14, further comprising a coating applicator in the housing to apply said coating onto said offset plate.

20. The direct inkjet offset lithographic printing system as recited in claim 15, wherein the dampening system washes at least a portion of the receptive coating off of said offset plate.

21. The direct inkjet offset lithographic printing system as recited in claim 16, further comprising a Far IR energy applicator disposed within said housing to apply energy to said offset plate.
